(19) United States
(12) Patent Application Publication
(10) Pub. No.: US 2004/0254836 A1
(43) Pub. Date: Dec. 16, 2004

(54) Method & system for distribution & management of electronic vouchers via carrier applications

(76) Inventors: Jutka T. Emoke Barabas, Honolulu, HI (US); Zoltan Horvath, Budapest (HU)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/766,411

(22) Filed: Jan. 27, 2004

Related U.S. Application Data
(60) Provisional application No. 60/443,523, filed on Jan. 28, 2003.

(51) Int. Cl. G06F 17/60

(52) U.S. Cl. 705/14

(57) ABSTRACT

A system and method for distribution and management of electronic vouchers (coupons) provides for embedding a Promotion Code Generator in a Carrier Application in the form of software, installing the Carrier Application on a user's computing device, using the Promotion Code Generator to generate a promotion code when the user operates the software in a predetermined manner, and validating a promotion award upon submission of the promotion code by the user to an Award Service Website for exchange and/or redemption. In the preferred system, the Carrier Application is mobile game software that is installed or downloaded to a mobile computing device. Promotion partners can initiate promotions through a Promotion Partners Website by selecting the game software, and specifying parameters for preloading it with promotions. The status of a promotion is tracked via a Promotion Bank in the promotion partner's account. The games are installed on users' mobile devices either by direct installation or by downloading from authorized distribution sites. The code generator in the game software generates promotion codes whenever the user operates the game successfully. Users can validate their awards online at the Award Service Website which updates the Promotion Bank in the partner's promotion account.

### RELATED US APPLICATION

This U.S. patent application claims the priority of U.S. Provisional Application 60/443,523 filed Jan. 28, 2003, entitled “2RPM (Repetitive Regenerative Promotional Marketing) System”.

### FIELD OF THE INVENTION

The present invention relates to the field of promotional marketing systems. More specifically, the present invention relates to the field of distributing and managing electronic vouchers for promotional marketing distributed through a carrier in the form of software.

### BACKGROUND OF THE INVENTION

Many companies in the world use promotions, especially through the issuance of coupons redeemable for discounts, prizes, or awards as a marketing tool to increase interest by the public in the goods and services they provide. Coupons are distributed in many ways, for example, via FSI (Free Standing Inserts), handout co-op advertising, handout off-store location advertising, in-ad advertising, in-pack advertising, in-pack cross ruff advertising, instantly redeemable coupons, Internet distributed coupons, and Sunday supplement insertion.

In 2001, consumers redeemed over 6.5 billion coupons valued at nearly 4 billion dollars. In 2002 coupon spending increased 4.5 percent to $6.8 billion. The number of CPG (Consumer Product Goods) coupons printed and issued also rose, jumping 3.8 percent to 248 billion in 2002, according to NCH Marketing Services. CMS Inc. estimates that the number of coupons distributed rose 3.4 percent to 336 billion in 2003.

The Internet, a network of many smaller networks, has become a potent distribution channel for information and information services. It is at present made up of more than 100,000 interconnected networks in over 100 countries, comprised of commercial, academic and government networks. It has become commercialized into a worldwide information highway and data base, containing information on virtually every subject known to humankind.

The proper and efficient use of the great amount of information available on various Internet sites has the potential of providing Internet users with a variety of information desired for businesses and individuals. In particular, users interested in certain segments of information on the Internet or users interested in certain Internet sites could benefit tremendously from having their information of interest available to them in an automated and interesting manner. Moreover, such users would benefit greatly from being constantly and automatically updated on new information as the new information becomes available on their sites of interest.

Due to the prevalence and popularity of World Wide Web (also called the “Web”) servers around the world, a great number of Internet users are particularly interested in receiving updated information of interest to them from various World Wide Web servers on the Internet. By way of background, the World Wide Web is an Internet facility that links documents locally and remotely. The Web document is called a Web page, and links in a page let users jump to other pages (hypertext) stored on the same server or on servers around the world. The pages are accessed and read via a Web browser such as Netscape Navigator or Microsoft Internet Explorer.

The Web has become the center of Internet activity because, among other reasons, Web pages, containing text, graphics and multi-media content are easily accessible via a Web browser. The Web contains the largest collection of online information in the world, and the amount of information is increasing. Current schemes for accessing a Web document require typing in the URL (Uniform Resource Locator) address of the home page in the Web browser. From there, the user starts “surfing” through the Internet via hypertext links to other documents that can be stored on the same server or on a server anywhere in the world.

The Web is a new market for the coupon industry. Internet studies show that more than one-quarter of Internet surfers search for and use coupons. Consumer Product Goods (CPG) marketers are beginning to devote more of their budgets to online marketing. They are offering coupons that customers can print out at home and redeem at the store. Consumers downloaded about 242 million coupons in 2002, an increase of 111 percent over the 114 million downloaded in 2001, according to Carolina Manufacturer Services Incorporated. Of those, 7.6 million were redeemed, which is more than a 400 percent increase from the 1.7 million in 2001.

Coupon distribution by Internet has a large benefit of using targeted coupons. It can drive sales and increase consumer loyalty. Coupons marketing can be used to target a community, zip code, gender, brand name, time frame, etc. The ability to track coupons used in marketing provides instant feedback on the success of individual promotions. Merchants can also track consumer response to calculate the ROI for individual promotion programs and then fine tune promotional options to achieve maximum results.

There are several ways of distributing Internet coupons. They can be distributed through email, pop-up windows, directories or banner ads and the like. These conventional promotional and/or advertising systems on the Internet reach users by popping up displays on their screens when they visit web sites or read their emails, or by offering discounts, coupons, and even cash to visit certain sites or to surf for extended periods. Since the viewer is not there on his or her own initiative and must be pulled in, the inducements must be high and the visibility afforded to the vendor or advertiser partner is limited.

Another Internet marketing tool are applications that bring in advertisements and promotions, called “Ad Ware” applications. The main feature is that they are free for the user, but contain advertisements the user will see during usage of the application. This type of marketing is very popular among the advertisers and application providers. But many users are not interested in seeing the advertisements but would rather just use the application. Because of this, the click through rate is very low on these types of promotions.

When users want to redeem an Internet coupon, they can do it usually in two ways. They can redeem it on an online web page, but with many types of promoters, it is not possible to redeem the promotion online. Or they can print out the coupon and then redeem it at a physical store location. But in many cases it is not convenient to print out a coupon, e.g., while using a mobile device such as a phone or PDA, or to go to a physical location.

There is currently a new generation of mobile devices, the so-called 2.5G, 3G and converged voice/data mobile devices, which combine the data capabilities of Pocket PCs and PDAs with the voice communication capabilities of mobile phones. These new mobile devices are expected to reach a large penetration of mobile Internet users in the next few years. These devices along with conventional handheld devices are capable of launching game applications that are interesting and exciting for users anytime and anywhere. Such devices provide users with powerful tools of immediacy, interactivity and mobility, and therefore can act as a most powerful marketing platform of the future.

Accordingly, what is needed is a new way of promotion distribution that employs vast Internet distribution with the powerful capabilities of mobile devices, wherein users are attracted to participate in promotions, and can redeem coupons from promotions in a convenient way. It would be particularly useful to have promotions generated ill a repetitive and regenerative way, without being limited by time, physical coupons, or physical locations.

### SUMMARY OF THE INVENTION

In accordance with one main aspect of the present invention, a method and system for distribution and management of electronic vouchers (coupons) comprises:

(a) a Carrier Application constituted by a software program operable by a user on a computing device;

(b) a Promotion Code Generator embedded in said Carrier Application configured to generate a unique promotion code when a user operates the Carrier Application in a predetermined manner; and

(c) an Award Service Website accessible on the Internet which is configured to maintain an award account for a user and to receive a submission of a promotion code generated by the Promotion Code Generator in a Carrier Application for validation and crediting to the user's award account as a validated promotion award corresponding to the promotion code submitted, whereupon the user can transfer, exchange, and/or redeem the validated promotion award.

The Carrier Application can be any type of software program that is distributed widely to users. Preferably, it is software that has everyday utility or interest to the user, so that the user uses or encounters use of the software frequently, such as games, digital media, digital videos, digital music files, calendar, planner, address book, pop-up functions, advertising, etc. The Carrier Application can reside on any type of device platform, including PCs, laptops, mobile PDAs, digital phones, computer kiosks, etc. The Carrier Application software may be installed on the device platform in any manner, including pre-installation, disk loading, Internet downloading, wireless data downloads, etc. The Promotion Code Generator can be activated to generate a promotion code upon the user operating the Carrier Application in a predetermined way in any manner, such as by running the Carrier Application, pushing a menu button, providing a correct answer to a question, performing a test in the Carrier Application, obtaining a score in the Carrier Application, using the Carrier Application a prescribed number of times, activating the Carrier Application on a prescribed date or time, etc. The promotion code can represent an award of any type, such as a discount coupon, a rebate offer, award points, a cash equivalent, a denominated value of some type, a redeemable gift, etc. All that is required is that the Carrier Application software reside on a computing device of any type used by a user carrying promotions loaded therein, and its embedded Program Code Generator generates a promotion code that the user can submit online and validate for an award upon operating the Carrier Application in a predetermined manner.

In a preferred embodiment of the above-defined system of the present invention, the Promotion Code Generator is embedded into a type of Carrier Application that engages the user in contests of skill or knowledge, such as educational or fun game applications. These applications can be operable on mobile devices and also on personal computers, whether online or offline. Each time a game is played to a specified level, score, etc., the Promotion Code Generator generates a promotion code as a form of electronic voucher for a discount coupon, gift, rebate, award points, etc. The promotion code is composed of a unique string of alphanumeric characters encoded with parameters representing the game name or ID, promotion ID, user ID, award won, and/or other identifying data such as date, time, user score, etc., which are encrypted together in a long number sequence for security. The Promotion Code Generator is typically activated when the user plays the game at any time offline, so that the computing device need not be coupled to an online service provider or to the Internet. Upon winning a promotion code, the user can present it online to the Award Service Website to be validated and credited as a validated promotion award to the user's award account. The user, can then transfer or exchange the validated promotion award with other users or with the participating promoter (promotion partner) and/or redeem them with the promotion partner's website or at participating merchant centers or websites. The promotions are initiated by promotion partners through a Promotion Partners Website and the status of the promotions are monitored via a Promotion Bank set up for the promotion partner's account. When an award is redeemed, confirmation is sent by the redemption center or site to the Promotion Partners Website so that the Promotion Bank can be updated.

In accordance with another main aspect of the present invention, a method and system for distribution and management of electronic vouchers (coupons) comprises:

(a) a Promotion Partners Website accessible by a promotion partner on the Internet which is configured to maintain a promotion account for a promotion partner to initiate an electronic voucher promotion, and to enable the promotion partner to specify parameters for the generation of promotion codes representing respective promotion awards from a selected Carrier Application to be distributed to users in the promotion;

(b) a Carrier Application constituted by a software program operable by a user on a computing device having embedded therein a Promotion Code Generator configured to generate an electronic voucher represented by a promotion code when the user operates the Carrier Application in a predetermined manner;

(c) means for configuring a Carrier Application selected by a promotion partner on the Promotion Partners Website so that its Promotion Code Generator is loaded with the capability to generate selected promotion codes when a user operates the Carrier Application in the predetermined manner; and

(d) means for distributing copies of the Carrier Application to be operated on computing devices of users participating in the promotion so as to generate promotion codes from their operation of the Carrier Application in the predetermined manner; and

(e) means for allowing users to submit promotion codes generated by the distributed copies of the Carrier Application for validation of promotion awards to the users and for tracking the status of the promotion awards through the participating partner's promotion account.

In a preferred embodiment of the above-defined system of the present invention, a participating partner subscribes to a promotion on the Promotion Partners Website by selecting a Carrier Application and a number or denominated value of promotion awards to be awarded through the Carrier Application. The Carrier Application is preferably educational or game software that is installed on or downloaded to the user's mobile device from a distribution site enabled by the Promotion Partners Website. With each specified promotion, a Promotion Bank is established in the partner's promotion account to monitor the status of promotion awards validated and/or redeemed in that promotion. The status of the specified promotion awards is initially “free”, but is changed to “validated” with each promotion code that is submitted and validated.

The promotion parameters selected by the promotion partner for the selected Carrier Application are used to determine the preloading of the selected game application with promotion codes. For distribution by downloading, the preloaded game application is transmitted to distribution websites authorized to distribute copies of the Carrier Application. The distribution websites may be authorized to download only up to a specified number of copies of the Carrier Application. The game copies may instead be pre-installed in user devices, or distributed offline through other channels, such as in stores, promotion packs, magazine inserts, etc.

Once the game application with the promotions is loaded onto their computing devices, users can operate the game software at any time, online or offline, and will generate the specified promotion codes whenever their level of play, score, etc., reaches a predetermined result. The users can validate their promotion codes through the Award Service Website where they maintain their award accounts. The validated promotion awards may be transferred or exchanged, or redeemed online at the promotion partner's website, or offline through physical channels such as store redemption centers or customer service centers. As promotion awards are validated and/or redeemed, the status of the promotion awards is monitored through the Promotion Bank in the promotion partner's account.

In accordance with a further main aspect of the present invention, a method for distribution of electronic vouchers (coupons) from a software carrier application operable on a computing device comprises:

(a) installing a Carrier Application on a user's computing device;

(b) providing a Promotion Code Generator embedded in said Carrier Application which is configured to generate a promotion code when a user operates the Carrier Application in a predetermined manner; and

(c) awarding an electronic voucher to the user in the form of a unique promotion code generated by the Promotion Code Generator when the user operates the Carrier Application in the predetermined manner, displaying the promotion code and any associated promotion information to the user on a display interface for the computing device, and storing the generated promotion code in memory on the computing device for later retrieval for validation, exchange and/or redemption.

In one mode of operation of the above-defined system, the number of promotion codes generated and/or the number of copies of the Carrier Application distributed can be unlimited, while the number of promotion codes that will be validated as promotion awards is limited by the total number or denominated value of promotion awards specified in the Promotion Bank. The status of the validated promotion awards are changed from “free” to “validated” in the Promotion Bank. When a promotion award is redeemed, the status of that promotion award in the Promotion Bank is changed back to “free”, so that it may be used for validating a next submitted promotion code. In this manner, the Carrier Application once deployed can be used repetitively and regeneratively to issue promotion awards that are continuously circulated through the Promotion Bank (until the expiration date of the promotion).

In another mode of operation of the above-defined system, the number of promotion codes and/or the number of copies of the Carrier Application distributed is limited to a total number or denominated value of promotion awards that can be validated in the Promotion Bank. Each copy of the Carrier Application can generate only a limited number of promotion codes that it is loaded with. When validated, the promotion awards may be redeemed from the Promotion Bank up to the allowed number or denominated value.

In yet another mode of operation of the above-defined system, the number of promotion codes and/or the number of copies of the Carrier Application distributed is unlimited, and the promotion codes are validated for award points. The award points can be accumulated in the users' award accounts until they have enough points to redeem it for a promotion award that is available from the Promotion Bank under its specified terms for redemption. In this manner, the Carrier Application once deployed can be used repetitively and regeneratively to issue unlimited numbers of award points which are redeemed for the types and numbers of promotion awards specified by the promotion partner in the Promotion Bank (until expiration of the promotion).

Other objects, variations, modes, features, and advantages of the present invention will be explained in the following detailed description of the invention, with reference to the appended drawings.

### BRIEF DESCRIPTION OF THE DRAWINGS

FIG. 1 is a schematic drawing illustrating the overall architecture of a system and method for distribution and management of electronic vouchers in the present invention.

FIG. 2 is a schematic drawing illustrating application of the system of FIG. 1 to the mobile gaming environment.

FIG. 3A is a logical block diagram of the communication architecture of one embodiment of the present invention.

FIG. 3B is a logical block diagram of the communication architecture of another embodiment of the present invention.

FIG. 3C is a logical block diagram of the communication architecture of a further embodiment of the present invention.

FIG. 4A is a logical block diagram of one embodiment of a carrier application of the present invention.

FIG. 4B is a logical block diagram of another embodiment of a carrier application of the present invention.

FIG. 5 is a data block diagram of a Promotion Code in the present invention.

FIG. 6 is a flow chart diagram illustrating the status of promotions in the Promotion Bank.

FIG. 7A is a logical block diagram of one embodiment of the 2RPM Award Service.

FIG. 7B is a logical block diagram of another embodiment of the 2RPM Award Service.

FIG. 8 is a logical block diagram of one embodiment of the 2RPM Partner Service.

### DETAILED DESCRIPTION OF THE INVENTION

In the following detailed description of the present invention, certain preferred embodiments of a system and method for distribution and management of electronic vouchers are described. The system is referred to herein as the “2RPM” system, i.e., the Repetitive & Regenerative Promotion Marketing” system. In the 2RPM system, the Carrier Application is a small footprint game software that is installed or downloaded to a mobile computing device, such as a laptop, PDA, or digital phone. Promotion partners can initiate promotions using selected game software through a Promotion Partners Website. The selected game software is preloaded with promotions and distributed through authorized distribution sites. The code generator in the game software generates promotion codes when the user operates the game successfully, such as by answering a question, playing to a certain skill level, or obtaining a specified score. Users can validate their awards online at an Award Service Website which communicates with the Promotion Partners Website and updates the Promotion Bank in the partner's promotion account. Users may exchange their awards at a separate Promotion Exchange Site. However, it to be recognized that any similar or equivalent types of Carrier Applications, code generator activation events, computing devices, installation or download methods, distribution methods, promotion validation methods, and accounting methods for users and partners may be used within the principles of the invention as disclosed herein.

In the following description, those methods, procedures, components, and devices that are well known to those in this field are referenced but not described in detail. Unless specifically stated otherwise in the following description, commonly used computer terminology such as “processing” or “computing” or “calculating” or “determining” or “displaying” or “recognizing” or the like, refer to the action and processes of a computer system, or other electronic computing device as commonly understood in the industry. Aspects of the present invention, described below, are discussed in terms of software programmed steps executed on a computer system. Aspects of the present invention are also discussed with respect to an Internet system including computing devices and servers connected together within the Internet environment. A “server” or “mobile device” or “user device” can be implemented via any type of general purpose computer or a special purpose computing device. Also included within the common understanding of computer systems are various peripheral devices for inputting or outputting commands, data, signals, information, etc., such as keyboards or keypads, cursors, mouse devices, trackballs, joysticks, electronic styluses, optical beam devices, sound input and output devices, communication ports and devices, display devices, etc.

Although many different types of computer systems can be used with the present invention, the preferred examples of mobile computer devices in the following detailed description include those based on the widely used Microsoft PocketPC(™), Symbian(™) or PALM(™) operating systems. Preferred examples of personal computing systems include those based on the Microsoft Windows(™), Apple Macintosh(™) or Linux operating systems, and the Intel x86, Apple G-Series or Motorola ARM processor architectures. Preferred examples of application programming environments include Microsoft Visual Basic(™), C+, or Sun Microsystem's Java(™). Preferred examples of Internet servers for operating websites include Microsoft Exchange(™) servers or Lotus Domino(™) servers or Apache(™) web servers. Preferred examples of software carrier applications include educational or fun games, quizzes, messaging, wagering, rating, searching, surveying, drawing, advertising, or other audio/visual applications or applets.

General System Architecture

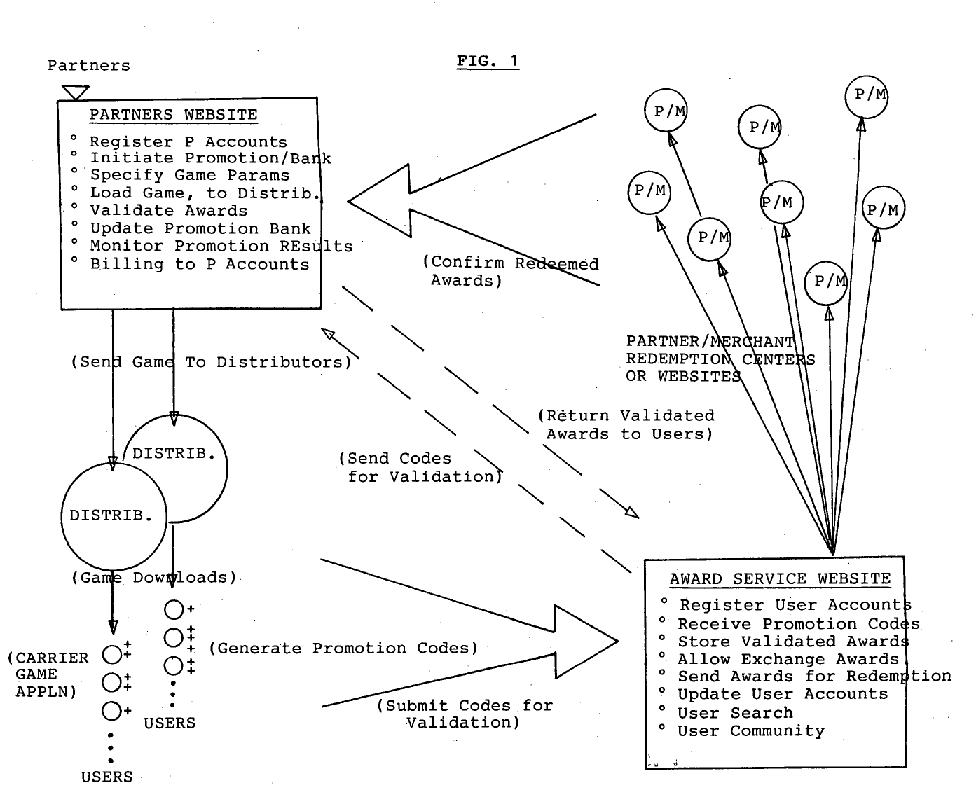

Referring to FIG. 1, the system and method for distribution and management of electronic vouchers in the present invention has the following main system components. A Promotion Partners Website is a website accessible on the Internet by promotion partners who have registered to participate in online promotions. A partner will establish a promotion account and track the status and results of each promotion in a Promotion Bank. A promotion partner may be a product vendor, retail merchant, distribution company, marketing company, advertising firm, promotion consolidator, etc. In the present invention, a promotion is carried out by distributing multiple copies of a Carrier Application, such as educational or fun game software, through Distributors (e.g., popular Internet websites for downloading mobile game software) to users for operation on their computing devices, such as mobile PDAs, PDA-phones, Java-enabled phones and mobile devices, etc. Each Carrier Application has an embedded Promotion Code Generator for generating electronic vouchers in the form of promotion codes that represent various types of discount coupons, rebates, awards, gifts, award points, or other incentives for user participation in the promotion.

Promotion codes awarded to a user of a Carrier Application are submitted for validation to an Award Service Website accessible on the Internet. The promotion codes awarded to a user on a particular computing device may be stored in the device memory or may be uploaded or synched to a user award management tool on a PC. When the user wants to claim their award(s), the promotion codes can be submitted to the Award Service Website by the user logging onto their account on the website and entering or uploading their stored promotion codes to the user's account. Alternatively, for those mobile devices that are enabled for email, SMS, or instant messaging, a tool may be provided with the mobile device to automatically send the promotion code to the user's account when the user clicks “send”.

The Award Service Site receives the entered or uploaded promotion codes in the user's account, then goes through a validation procedure by sending a validation request for each promotion code to the Promotion Partners Website which decrypts the promotion code, confirms that its decrypted components indicate that the promotion code was generated from an authorized Carrier Application for an authorized promotion in accordance with the specified conditions for receiving an award. The Promotion Partners Website then returns confirmation of a validated award to the user's account at the Award Service Website, such as by attaching a unique promotion authorization code to the award's promotion code. The Award Service Website may be configured to enable the user to transfer or exchange validated award codes with other users, or to submit a validated award code for redemption of an actual award item at the promotion partner's or a participating merchant's website (online) or at a physical store or redemption center of the promotion partner or a participating merchant (offline). Alternatively, a separate Promotion Exchange Site may be set up or authorized as an affiliated entity for this purpose. Upon redemption, the promotion partner or participating merchant sends confirmation to the Promotion Partners Website (online) that the award has been redeemed so that the partner's promotion account (Promotion Bank) can be updated (discussed further below).

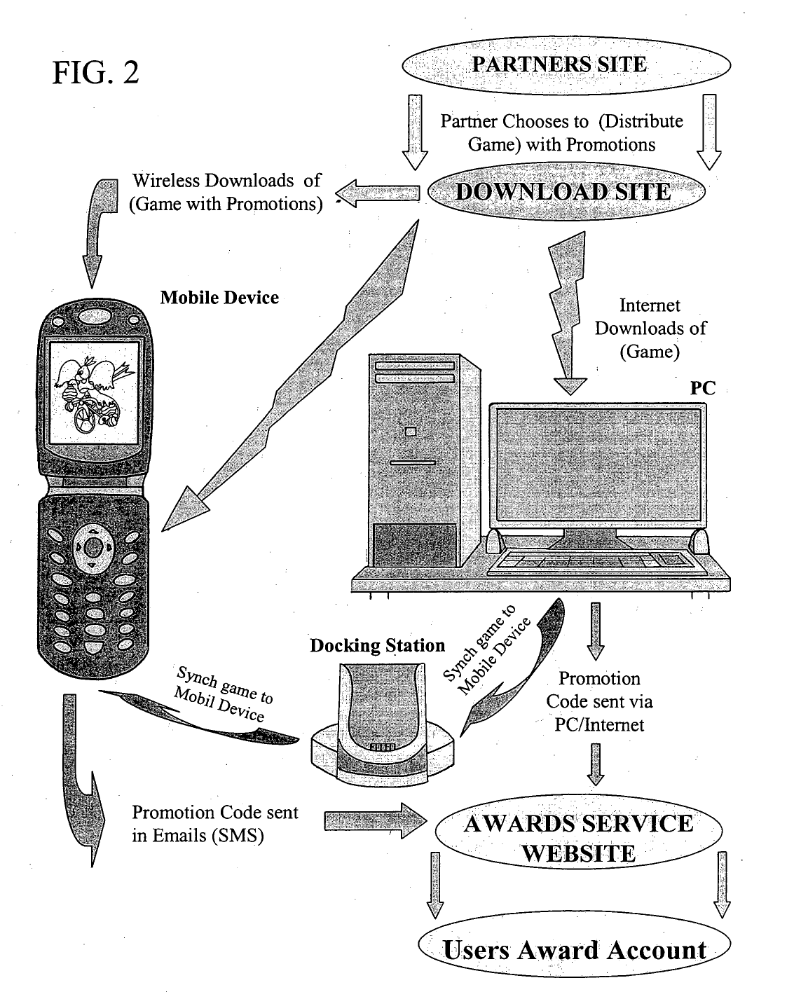

Referring to FIG. 2, a particularly suitable environment for bringing promotions to users is through mobile games as the Carrier Application played on mobile computing devices, such as laptops, PDAs, or digital phones. Partners can initiate a promotion from the Partners Site by choosing a particular game and having it loaded with the specified promotions. The games are then distributed through authorized Download Sites which can download a game by wireless data transmissions to the mobile device, by pre-installing it on the user's mobile device, or by downloading it to a user's PC where it is transferred to the mobile device by synching through with the device docking station. The user can submit promotion codes generated by playing the game on the mobile device by entering the codes or synching a code file on a PC and submitting them online to the Award Service Website or, if the mobile device is so configured, by sending the promotion code in an email message or SMS text message to the Award Service Website from the mobile device. The Award Service Website can then validate the promotion award to the user's award account.

Initiating a Promotion

The initiation of a promotion in a Carrier Application will now be described in greater detail. Referring again to FIG. 1, a promotion is initiated by a promotion partner accessing their promotion account on the Promotion Partners Website and specifying the parameters for a desired promotion, such as:

Promotion Name or ID Number: The promotion partner can select one of a number of game applications offered on the website. A popular game application may incur a higher promotion cost than a lesser one (due to royalties that may have to be paid to the game author or publisher). The Name or ID alphanumeric-is used to confirm that the promotion was authorized when a promotion code is presented to the Award Service Website.

Number of Promotion Offers: This is the number of promotion offers that may be registered into the Promotion Bank having the status “free”, which indicates that it is available to be awarded to a user.

Denominated Value of Promotion Offers: The total denominated value of promotion offers in a promotion may be specified instead of the number of promotion offers. This is particularly useful where different types of promotion awards may be issued by the same Carrier Application. For example, for Level 1 play a user may be awarded a $10 discount, for Level 2 play a $30 discount, and for Level 3 play a $50 discount. If the total denominated value of $500 is specified, then the Code Generator can generate any combination of Level 1, Level 2, and Level 3 awards that add up to $500.

Promotion Description: This is a description of the promotion offer that can be made readable on the Carrier Applications' user display interface when the user wins a promotion award, and/or when the user presents the promotion code for validation on the Award Service Website.

Promotion Graphic Image: (optional) A graphic image for the promotion may be made viewable on the Carrier Applications' user display interface and/or upon submission to the Award Service Website.

Expiration Time of Promotion: This is the time interval set for expiration of a promotion offer. For example, if a user downloads a Carrier Application for a promotion on the 1^{st} of January and the expiration time is one month, then the promotion offers that can be generated by the Carrier Application will terminate (cease being generated) on the 1^{st} of the following month of February. After the expiration date no further promotion offers will be awarded by the Carrier Application. To notify the user, the expiration date may also be made viewable on the Carrier Applications' user display interface and/or upon submission to the Award Service Website.

Global Expiration Date of Promotion: (optional) This is the last calendar date that the Award Service Website will accept a promotion code for validation. This will notify the user to submit the promotion code for validation by a certain date.

Maximum Number of Offers Redeemable: (optional) The system can track the number of redeemed promotion awards in a promotion and terminate further awards if a maximum number is reached.

Awards for Scores or Levels of Game Play: The promotion partner can specify what types of promotion awards should be awarded for what scores or levels of game play.

With each specified promotion, a Promotion Bank is established in the partner's promotion account to monitor the status of available, validated and/or redeemed promotion awards specified for that promotion. The status of available promotion awards is initially “free”, but is changed to “validated” with each promotion code that is submitted and validated, and may be changed back to “free” when the promotion award is redeemed. In this manner, the partner's promotion account is used to monitor the status of each promotion. Data concerning the promotion launch, status, and results may be used for billing the partner's promotion account for fees, commissions, and/or revenue shares associated with the promotion.

Promotion Code Generator

A typical Carrier Application suitable for use in the present invention is an education or fun game application. Such game applications challenged the skills and knowledge of the user within the context of an action sequence or a narrative or an engaging test sequence. Due to the expanded capabilities of present day mobile devices, such as laptops, PDAs, Pocket PCs, PDA-phones, and digital phone clients, a game application can be readily accommodated in the typical RAM space of 2 Megabyte to 64 Megabyte provided in current mobile devices.

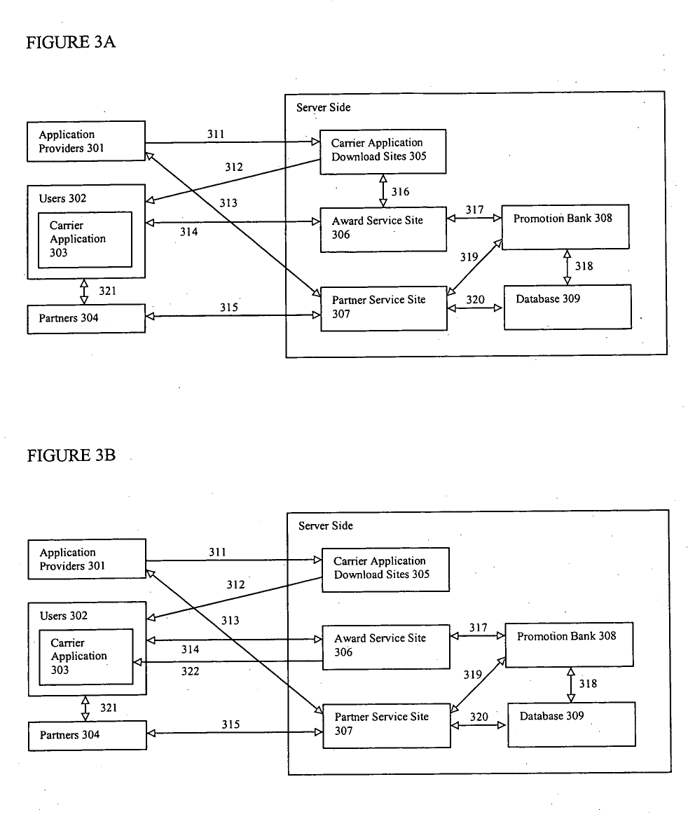

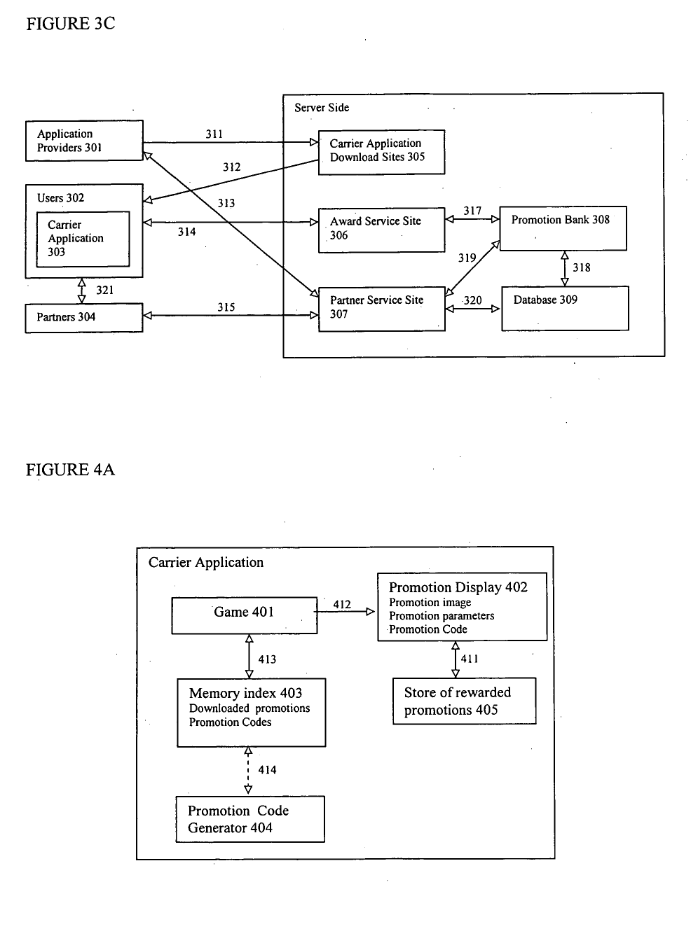

Referring to FIG. 3, the Carrier Application has embedded within it a Program Code Generator which is a program module that handles the generation, display, and storage of promotion codes. Each promotion code is generated when the user operates the game application and achieves a specified play level, conclusion, score, etc. The game application then passes a message to the Program Code Generator to generate a promotion code. The Program Code Generator generates a unique promotion code using parameters that identify the Carrier Application, the user/device, the promotion/application, the user's score or level of game play, and/or the promotion award to be represented by the promotion code.

The Promotion Code Generator is activated as part of the install procedure upon downloading a game application. The install procedure sets up a Code Generator routine which runs as a thread in the background of the game, and also sets aside a memory space for storing carrier, user, promotion, and game play data to be used in generating an award code. If a limited number of permissible promotion codes has been specified (by the Promotion Partner), the Code Generator sets up a countdown index of the permissible number of promotion codes. If different types of promotion codes are awarded for different scores or levels of play, the Code Generator sets up a table of threshold scores or different levels of play. If an expiration date has been specified (by the Promotion Partner), the Code Generator sets up a countdown date clock for generating promotion codes.

Each time the user launches the game, the game application activates the Code Generator and stores the current date and time. If the user reaches a specified score or play skill level, the game application sends an award message to the Code Generator. The Code Generator checks the promotion code index, score or play level table, and/or date clock to determine if and what type of Promotion Code is to be generated. The Promotion Code is then generated and encrypted for security, for example, as a 20-character long serial number. The Code Generator causes an promotion award display to be displayed on the user display interface, for example, showing an award message such as “You have won a $50 discount on Blaster Cellphones!—Here is your promotion award code: XXXX-YYYY-ZZZZ”, along with a graphic image of the promotion partner's product(s). In the preferred embodiment, the user can press a button on the game display interface to save the promotion code in a User Data file or to recall it later when the user wants to validate the promotion code for redemption or exchange. The user can browse the stored promotion codes and delete unwanted ones (if they have already been redeemed or have expired) via the device's display interface.

The Code Generator also performs any required housekeeping routines, such as decrementing the promotion code index, and/or checking the score or play level table and date clock. If no more promotion codes are to be awarded, the Code Generator can cause a message to be displayed to the user that all promotion codes have been used or have expired and that no more can be awarded. An example of the source code for a Sample Code Generator program is appended in Appendix 1.

In current Internet models of distribution of downloadable games, game software can be widely distributed online by downloading from popular distribution websites. The partner's parameters for the Carrier Application specified for the promotion are employed to preload the selected game application for generating the specified promotion codes. The preloaded game application is then transmitted to one or more distribution websites for downloading copies of the Carrier Application to user. The distribution website(s) is/are authorized to download up to a specified number of copies of the Carrier Application in a given promotion. Copies of the software game may also be distributed through offline channels, such as in stores, promotion packs, or inserts.

Once downloaded, users can operate the game software at any time, online or offline, and will generate promotion codes whenever their level of play, score, etc., reaches a predetermined result. The Carrier Application stores information on the promotion offers that are offered in a given promotion, and also the promotion parameters (as listed above) that may be used to generate the promotion codes. When the Carrier Application determines that a user has won a promotion award, by achieving a certain score, result, or level of play, it calls the Promotion Code Generator to generate a new promotion code corresponding to the appropriate promotion offer. The Promotion Code Generator determines and applies the needed parameters for code generation.

The Promotion Code Generator executes an algorithm which generates a unique serial number based on the parameters of the Carrier Application and the promotion. The Promotion Code Generator is integrated into the 2RPM Carrier Applications in binary code. The memory address where the Promotion Code Generator code is positioned may be different for different Carrier Application types in order to avoid tampering with the code. The promotion code is a unique “serial” number generated from several parameters, such as the following:

Carrier Application Data:

1. Carrier Application Type (Name or ID): This may be 8 bits wide data with 256 possible values. It shows what Carrier Application type the user is using.

2. Carrier Application Copy ID. This may be generated serially or by a random number generator during downloading of the copy of Carrier Application. It may be 16-bit wide with 65536 potential values. This identifies each unique copy of the Carrier Application. It may happen that two or more copies are given the same ID number, but it is not crucial, since this parameter is used primarily for statistics.

User Specific Data:

1. User ID: This may be a username input by the user when queried by the Carrier Application, or it may be the serial number used to identify the user's computing device. It is used if it is necessary to differentiate between users or to confirm a particular user when generating a promotion code.

2. User Age Level: For multi-age games, this may be input by the user when queried by the Carrier Application, such as Child Level age 5-12, Teen Level age 13-17, Young Adult Level age 18-25, Adult Level age 26-54, and Senior Level age 55+. This can be handled by 3-bit wide data.

3. User Location: For multi-language or multi-cultural games, this may be input by the user when queried by the Carrier Application. For example, to differentiate among 128 countries or regions, 7-bit wide data may be used.

4. Computing Device Type: This indicates the type of computing device the user uses to operate the Carrier Application. It may be coded into the Carner Application at the time of requested downloading for a particular type of computing device, or it may be input by the user when queried by the Carrier Application. 3-bit wide data can differentiate between 8 potential values.

Promotion Specific Data:

1. Promotion Type: This parameter can indicate the type of promotion, the source of issuance, or the method of promotion distribution being used. 3-bit wide. data can differentiate between 8 potential values.

2. Promotion ID: A promotion ID number may be used to differentiate the specific individual promotion. For example, it may be the ID number of the-assigned Promotion Bank, using 31 bits in the promotion code to differentiate between 2 billion potential values.

3. Promotion Code Index Number: This may be the number of the currently generated promotion code, if the number of codes that can be generated by the Carrier Application is to be limited. 11-bit data for this field indicates 2048 potential values.

4. Promotion Code Date: This may be the date indicated by the system clock of the computing device at the time of generation. 10-bit data is sufficient to identify month, day, and year.

5. Other Promotion Code Data: This may be reserved for any other data that may be deemed relevant for the promotion code. For example, it may indicate the difficulty level of the reward. It may be 8-bit data with 256 potential values.

Operation of the 2RPM System

The repetitive and regenerative promotion marketing system (called “2RPM system” herein) will now be described for three different embodiments for implementing the system. According to one embodiment of the present invention as shown in FIG. 3A, in order for users 302 to obtain promotion-loaded downloads 312 of a Carrier Application 303 via the Internet from the Carrier Application Download Site 305, the system first downloads a limited number of “free” promotions 317 from the Promotion Bank 308 through the 2RPM Award Service 306 and installs them in master copies 316 of the Carrier Application supplied to the Carrier Application Download Site 305. During the download 316, the 2RPM Award Service 306 records the Promotion Code(s) for each of the promotions that is downloaded, using the promotion ID data and the Carrier Application and user ID data obtained during downloads 316 from the Carrier Application Download Site 305. The status of the downloaded promotions are turned to “validated” and have an expiration date set. The new status, expiration date and the Promotion Code(s) are stored in the Promotion Bank 308.

According to another embodiment as shown in FIG. 3B, when a user 302 downloads 312 a Carrier Application 303 via the Internet, the given Carrier Application 303 downloads via 322 a limited number of “free” promotions from the Promotion Bank 308 through the 2RPM Award Service 306. The status of the downloaded promotions is turned to “validated” and have an expiration date set. The new status and expiration date are stored in the Promotion Bank 308. When a user is rewarded by a Carrier Application 303, he/she receives one of the promotions that were downloaded and the Carrier Application 303 generates a unique Promotion Code for it. The user at 314 must validate the Promotion Code on the 2RPM Award Service 306. During the validation the Award Service 306 attaches a “validated” promotion to the given Promotion Code. The Promotion Code contains the Promotion ID of the promotion the user was rewarded.

According to a further embodiment as shown in FIG. 3C, when a user 302 is rewarded by a Carrier Application 303, he/she receives a general promotion offer in the form of a unique generated Promotion Code. The user 302 should validate at 314 the promotion offer on the 2RPM Award Service 306. During the validation 314 the Award Service 306 attaches at 317 a “free” promotion to the given Promotion Code. The status of that promotion is turned to “validated” and has an expiration date set. The new status, expiration date and the Promotion Code are stored in the Promotion Bank 308.

The user can redeem at 321 the promotions that were validated (where the status of the promotion is “validated”). During the redemption the user submits at 321 the Promotion Code to the 2RPM Promotion Provider Partner 304, which will authorize at 315 the promotion on the 2RPM Partner Service 307. After the redemption the promotion's status will turn to “free” again and is ready to be distributed again. If a given, already validated promotion's expiration date expires, the status of the promotion will turn into “free” and be ready to be distributed again.

Carrier Application in the 2RPM System

The 2RPM System distributes the promotions via applications called “Carrier Application” 303. The Carrier Applications are developed by Application Providers 301 and are downloadable when placed on the Carrier Application Download Sites 305 for launch on computer systems 210. Preferably, the Carrier Applications are quiz or game applications. During the usage of the Carrier Application, based on the specific rules of the application, the participants may receive rewards as different promotions or as general promotion offers.

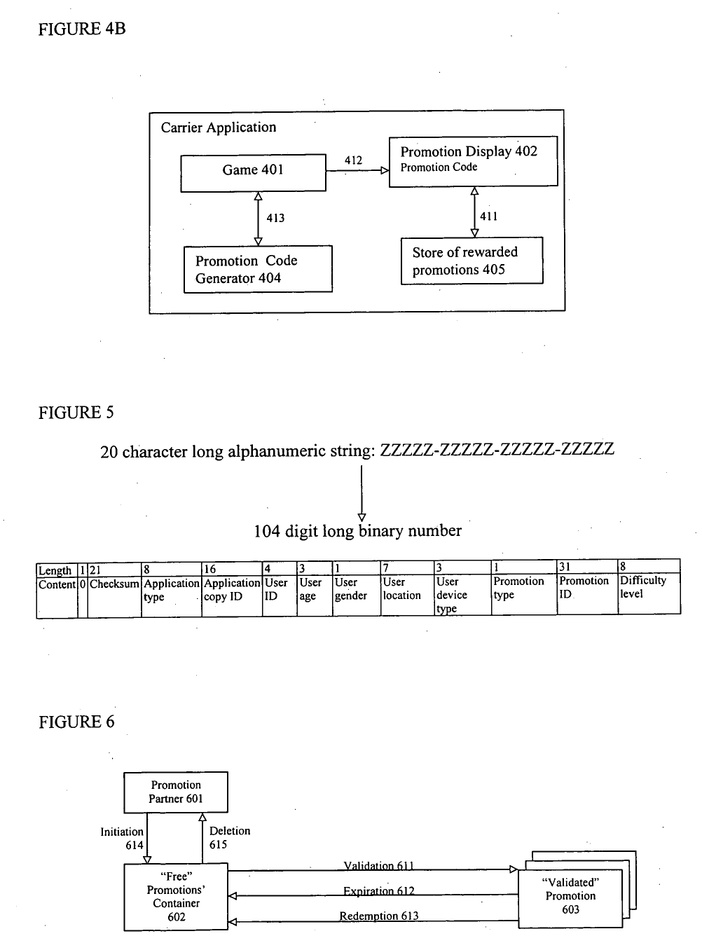

According to one embodiment, when a user downloads a Carrier Application via the Internet, as shown in FIG. 4A, the given Carrier Application downloads or carries a limited number of “free” promotions from the Promotion Bank through the 2RPM Award Service. During the download, the 2RPM Award Service generates the Promotion Code(s) for each of the promotions downloaded or the Promotion Code will be generated at 414 by the Promotion Code Generator 404 embedded in the Carrier Application when the given promotion is rewarded. For the code generation, it uses the promotion ID data and data that come from the given Carrier Application.

The Carrier Application stores the downloaded promotions in the memory index 403 with all the promotion parameters listed above. When the Carrier Application's game 401 determines that an award of a new promotion is to be issued to the user, it uses one of the promotions at 413 that were downloaded. The user can view at 412 the rewarded promotion, and the data concerning it on the user interface 402 of the Carrier Application. If the Carrier Application is out of the downloaded promotions, it informs the user about it, and may let the user download new promotions from the 2RPM Award Service.

According to another embodiment, the Carrier Application as shown in FIG. 4B contains the 2RPM Promotion Code Generator 404. When the Carrier Application's game 401 is to reward the user, it calls at 413 the Promotion Code Generator 404 to receive a new Promotion Code of a general promotion offer. For generating the new code, the Carrier Application provides at 413 the needed parameters to the Promotion Code Generator 404. This type of Carrier Application is able to display at 412 only the Promotion Code which represents the promotion offer, but which need to be validated on the 2RPM Award Service for a factual promotion.

The Carrier Application lets the user store at 411 the rewarded promotions and Promotion Codes in a file storage 405 of the user's device. The user can redeem the promotion online by inputting the Promotion Code in a browser on an Internet-connected PC. Alternatively, if the user's device for the Carrier Application is connected for wireless phone or for online Internet service, the Carrier Application can be programmed to automatically send the Promotion Code to the Award Service's email address upon user input of a button request by inserting it into a standard email template, or to a phone SMS/MMS messaging service for the Award Service by inserting it into a phone text messaging template.

Promotion Code Generator in the 2RPM System

The Promotion Code Generator is an algorithm which generates a unique serial number of the information of the Carrier Application and the promotion as described previously. The Promotion Code Generator is integrated into the 2RPM Award Service or the Carrier Applications as a binary code program. The memory address where the Promotion Code Generator code is positioned is different for all Carrier Application type to avoid easy tampering with the code. Preferably, the code contains 20 alphanumeric characters which can accommodate a large range of numbers of 20 to the 36^{th} power. The largest number of that is ZZZZZ-ZZZZZ-ZZZZZ-ZZZZZ which equals to a 104 digit long number of second power. It means that any 103 digit long binary number has a definite code. An example of a data block diagram for a Promotion Code is shown in FIG. 5.

The information contained in the Promotion Code requires 82 bits, with 21 bits remaining for check sum coding. First, the algorithm generates a 21-bit check sum of the 82 bits, then assembles the 103-bit binary number as a unique number. The algorithm uses the highest digits of the number for the check sum. If two codes different only by one bit, the check sum is also changed. If a higher value digit of a number changes, this small change will cause a large change of the whole number in the binary number. For example, if all 82 bits of data are 0, the code will be BCYMS-O7U09-SR3A5-5K1Z4. If we change only one bit of the 82 bits of data to 1, the code will be HXWU0-MJFS6-GZJ24-UT2IO. Therefore, the Promotion Code is very difficult to counterfeit even if a counterfeiter has access to codes generated on a particular user's device or samples of promotion codes from other sources.

For each 82 bits of data there is one definite check sum. The decoding will be successful only if the check sum and the data part of the number match. The 21 bits long check sum has about 2 million variations. So a 82-bit data field may be available in 2 million variations of codes, but only 1 of the 2 million will be valid and authenticated by the 2RPM Award Service. A sample source code for the Promotion Code Generator is shown in Appendix A.

2RPM Promotion Bank

The 2RPM Promotion Bank is a server side component of the 2RPM system. It operates as a storage of the promotions as shown in FIG. 6. The 2RPM Award Service and 2RPM Partner Service use the Promotion Bank. The users and the Partners may handle the Promotion Bank's data only through these services. The Promotion Bank stores the promotions initiated by the Partners via the Partner Service. The Partners have an open storage of a limited number of promotions in the Promotion Bank.

When a Partner 601 registers at 614 a new type of promotion, it should define the parameters of the promotion as listed above. The Partner may register more promotion types, but the sum of the number of promotion offers of all promotion types may not exceed the limit allowed for the Partner. When a Partner 601 registers a new promotion type, it is stored in the Promotion Bank as a package of “free” state promotions 602.

When a promotion offer is validated by the Award Service, the number of “free” state promotion is decreased by one as shown at 611. If the number of “free” state promotions is zero, the Award Service can not validate more copies of the given promotion type. The Promotion Bank stores the “validated” promotions uniquely with its unique data 603. These are the Promotion ID, the expiration date and the Promotion Code if the promotion already has the code attached. The Promotion Bank generates the Promotion ID which is a 31 bit long binary counter increased by one in case of each promotion that is validated.

If a “validated” state promotion is redeemed, the status of the promotion will be turned to “free” again. It will be deleted from the store of “validated” promotions and the number of “free” state promotions is increased by one as shown at 613.

The Database 309 also stores the statistical data which are available to the Partners 304 and Application Providers 301 via the Partner Service 307. The Partners and Application Providers have access to browse the 2RPM system global statistical values and the values refers to its own promotion or application types. These statistical values include the following.

The number of redeemed promotions of the given promotion type: If a user redeems a promotion at the Partner, this number increases by one.

The number of application software hits downloaded by the users: Since the Partners can specify which application is to be used as the carrier of its promotions, it is an important for them to know the download hits.

The number of promotions of each carrier application type validated and redeemed: This value is available globally for the 2RPM system and for each promotion and application type.

The users' age, gender, location and device type statistics of redeemed promotions globally and for each promotion and application type.

The Promotion Bank may also store the commission reports for the Partners based on its maintenance of records of the redeemed and/or validated promotions.

2RPM Award Service

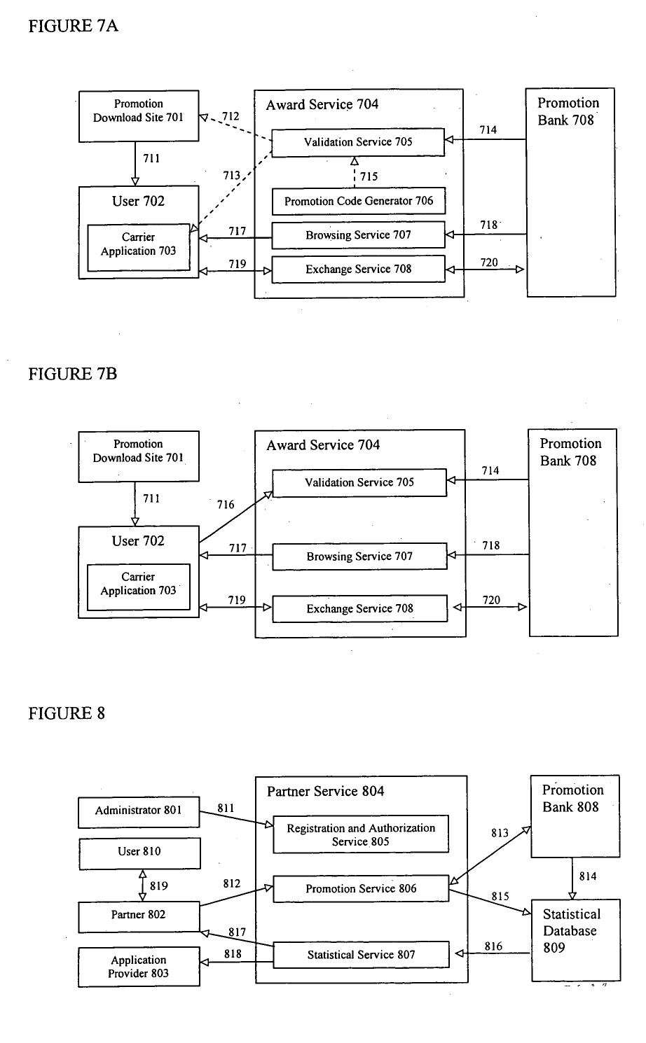

The 2RPM Award Service is a server side component of the 2RPM System and is a Web based service that also communicates with the Promotion Bank component. In one embodiment, as shown in FIG. 7A, when a user downloads at 711 a Carrier Application 703 via the Internet, the Promotion Download Site 701 downloads at 712, or during the installation the given Carrier Application downloads at 713, a limited number of “free” promotions from the Promotion Bank 708 through the Validation Service 705 of Award Service 704. During the download, the Award Service's Promotion Code Generator 706 generates at 715 the Promotion Code or the Promotion Code will be generated by the Carrier Application 703 when the given promotion is rewarded. The status of the downloaded promotions becomes “validated” in the Promotion Bank. When the user refers to the Promotion Code on the Award Service, the service will identify the promotion stored in the Promotion Bank by the Promotion ID which is coded into the Promotion Code.

According to another embodiment as shown in FIG. 7B, when the Carrier Application 703 is to reward the user, it calls the Promotion Code Generator (built in the Carrier Application) to receive a new Promotion Code of a general promotion offer. In this case the user should validate at 716 his/her reward on the Validation Service 705 of Award Service 704. The Award Service asks at 714 for a “free” promotion from the Promotion Bank 708, which as much as possible performs the conditions the Partner has set.

The Award Service enables users to browse at 717 their already rewarded and validated promotions which are not yet redeemed. The users type the Promotion Code of the promotion they would like to browse on the Browsing Service 707. The Award Service displays the data of the promotion from the Promotion Bank.

The Award Service enables the users to exchange at 719 their already rewarded and validated promotions which are not yet redeemed. The users type the Promotion Code of the promotion they would like to exchange on the Exchange Service 708. The Award Service offers a list of limited number of “free” promotions. The users may select one offer of the list or asks for a new offer list. If the user selects a preferred promotion, the selected promotion will be attached 720 to the Promotion Code in the Promotion Bank 708 and the state of the promotion becomes “validated”. The promotion that was exchanged then becomes “free” in the Promotion Bank.

2RPM Partner Service

The 2RPM Partner Service is a server side component of the 2RPM System as shown in FIG. 8. It is a Web based service and uses the Promotion Bank and Statistical Database components. In the embodiment described here, the Partners 802 and Application Providers 803 are enabled to manage their promotions and statistics through the Partner Service 804 web-based interface. The Partner Service requires an authorization of the Partners and Application Providers before using the service. The Administrator 801 is enabled to register 811 new Partners and Application Providers. The Partners 802 can register at 812 new promotion types on the Partner Service as detailed in the sections above. The Partners 802 can also delete at 812 any promotion types on the Partner Service. If a promotion type is deleted, the number of “free” promotions of the given type will be zero and redeemed or expired promotions will not be turned to a “free” state. The already validated promotions will not be deleted, but will either redeemed or expired.

The Partners can change at 812 the promotion's data listed in points above. The changes will be effective only for the promotions validated after the date of change. The Partners 802 and Application Providers 803 can also browse at 817 and 818 the statistics of the 2RPM system through the Partner Service as described previously. The redemption of the promotions at 819 may happen in several ways, e.g., (i) online redemption on the Partner's web site; (ii) personal redemption at the Partner's store; or (iii) redemption by mail, fax or email to the Partner.

For the redemption, the user 810 should know and submit at 819 the Promotion Code. The Partner must check at 812 the validity of the promotion on the Partner Service 804 online. During this process, the Partner Service checks the validity of the Promotion Code, and also checks the existence of the given Promotion Code in the Promotion Bank 808. If everything is right, Partner Service 804 confirms the redemption of the promotion and the state of the promotion becomes “free” in the Promotion Bank.

While certain embodiments have been described above, it is understood that many other modifications and variations may be devised given the disclosed principles of the invention. It is intended that all such embodiments, modifications and variations be considered as within the spirit and scope of this invention, as defined in the following claims.

```
// PromoCodeGen.h: interface for the CPromoCodeGen class.
//
//////////////////////////////////////////////////////////////////////
#if !defined(AFX_PROMOCODEGEN_H_C713E7BC_8909_4EC1_80C0_074516619968_INCLUDED_)
#define AFX_PROMOCODEGEN_H_C713E7BC_8909_4EC1_80C0_074516619968_INCLUDED_{—}
#if_MSC_VER > 1000
#pragma once
#endif // _MSC_VER > 1000
/** Data is an information block described
  * with 4 unsigned longs(int32). The low-order
  * unit is the 0-th.
  */
#define DATA_LENGTH 4
class CData
{
protected:
  unsigned long data[DATA_LENGTH];
  mutable char* str;
public:
  static void mul32×32(unsigned long m1, unsigned long m2, unsigned long& rsLo, unsigned long& rsHi);
public:
  CData( );
  CData(const CData& o);
  ˜CData( );
  unsigned long* getData( ) { return data; }
  unsigned long* getData( ) const { return (unsigned long*)data; }
  const CData& operator= (const CData& o);
  bool operator== (const CData& o) const;
  const char* toString( ) const;
  void reset( );
  bool isNull( ) const;
  unsigned long divide(unsigned long div);
  void multiply(unsigned long mul);
  void add(unsigned long add);
};
/** Code is a string consisting digits(0-9)
  * and uppercase letters of british alphabet(A-Z).
  * The string length is 20 characters, therefore
  * 36\hat{ }20 code variations exist.
  * Note: 2\hat{ }103 < 36\hat{ }20 < 2\hat{ }104
  */
#define CODE_LENGTH 20
class CCode
{
public:
  class CIterator
  {
  public:
    CIterator(const CCode& ccode);
    void reset( );
    bool hasNext( );
    char* getNext( );
  private:
    const CCode& codeObj;
    long  ndx;
  };
  class CRevIterator
  {
  public:
    CRevIterator(const CCode& ccode);
    void reset( );
    bool hasPrev( );
    char* getPrev( );
  private:
    const CCode& codeObj;
    long  ndx;
  };
  CCode(char separator, long sepAfterEvery, const char* codestr=0);
  CCode(char separator, long* sepPositions, long sepPosCount, const char* codestr=0);
  CCode(const CCode& o);
  ˜CCode( );
  const CCode& operator= (const CCode& o);
  bool operator== (const CCode& o) const;
    void reset( );
  const char* toString( ) const { return code; }
  char getSeparator( ) const { return sepChr; }
protected:
  char sepChr;
  char* code;
  long* seps;
  long nSep;
};
/** CField is a value representation, whose extent
  * is specified as template parameter.
  */
template<int bitcount>
class CField
{
public:
  CField(unsigned long value = 0)
    : field(value & ((1I << bitcount) − 1))
  { }
  operator unsigned long( ) const { return field; }
  unsigned long serialize(bool in, unsigned long stream[], unsigned long location)
  {
    unsigned short segm = LOWORD(location);
    unsigned short offset = HIWORD(location);
    unsigned short rem = 32 − offset;
    if( in )
    {
      if( rem < bitcount)
      {
        setField(stream[segm] , offset, 0 , rem );
        setField(stream[segm+1], 0 , rem, bitcount − rem);
      }
      else
        setField(stream[segm], offset, 0, bitcount);
    }
    else
    {
      if( rem < bitcount)
      {
        getField(stream[segm], offset, 0 , rem );
        getField(stream[segm+1], 0 , rem, bitcount − rem);
      }
      else
        getField(stream[segm], offset, 0, bitcount);
    }
    offset += bitcount;
    segm += offset / 32;
    offset = offset % 32;
    return (((unsigned long)offset) << 16) | ((unsigned long)segm);
  }
protected:
  void setField(unsigned long srcvalue, unsigned short srcoffset, unsigned short dstoffset, unsigned short bitcnt)
  {
    if( dstoffset == 0 )
      field = (srcvalue >> srcoffset) & ((1I << bitcnt) − 1);
    else
    {
      field & = ˜( ((1I << bitcnt) − 1) << dstoffset );
      field |= ((srcvalue >> srcoffset) & ((1| << bitcnt) − 1)) << dstoffset;
    }
  }
  void getField(unsigned long& dstvalue, unsigned short dstoffset, unsigned short srcoffset, unsigned short bitcnt)
  {
    dstvalue & = ˜( ((1I << bitcnt) − 1) << dstoffset );
    dstvalue |= ((field >> srcoffset) & ((1| << bitcnt) − 1)) << dstoffset;
  }
public:
  unsigned long field;
};
/** Promotion code generator class.
  * The four subclasses listed below are used to set
  * the input parameters the code is built from. A 21 bit
  * size CRC is added to input parameters.
  * Static methods encryptData and decryptData should
  * be used to generate code from input parameters and
  * inverse. decryptData returns false, if CRC fails.
  */
class CPromoCodeGen
{
public:
  //---------------------------------------------
  class CPromoSegm
  {
  public:
    CPromoSegm(CField<12> _promo=0, CField<10> _time=0)
      : promoID(_promo)
      , timeMS(_time)
    { }
    void setPromotionID(CField<12> _promo) { promoID = _promo; }
    void setTimeInMSec(CField<10> _time) { timeMS =_time; }
    CField<12> getPromotionID( ) const { return promoID; }
    CField<10> getTimeInMSec( ) const { return timeMS; }
    unsigned long serialize(bool in, unsigned long stream[], unsigned long _loc)
    {
      _loc = promoID.serialize(in, stream, _loc);
      _loc = timeMS.serialize(in, stream, _loc);
      return _loc;
    }
  private:
    CField<12> promoID; // Promotion ID: 4096 lehetoseg: 12 bit
    CField<10> timeMS; // System time ms: 1000 lehetoseg: 10 bit
  };
  //---------------------------------------------
  class CApplSegm
  {
  public:
    CApplSegm(CField<8> _type=0, CField<16> _instance=0)
      : typeID(_type)
      , instID(_instance)
    { }
    void setTypeID(CField<8> _type) { typeID = _type; }
    void setInstanceID(CField<16> _instance) { instID = _instance; }
    CField<8> getTypeID( ) const { return typeID; }
    CField<16> getInstanceID( ) const { return instID; }
    unsigned long serialize(bool in, unsigned long stream[], unsigned long _loc)
    {
      _loc = typeID.serialize(in, stream, _loc);
      _loc = instID.serialize(in, stream, _loc);
      return _loc;
    }
  private:
    CField<8> typeID; // Carrier Application type: 256 lehetoseg: 8 bit
    CField<16> instID; //Carrier Application copy ID (véletlen generátor telepitéskor hozza létre): 65536 lehetoseg: 16 bit
  };
  //---------------------------------------------
  class CUserSegm
  {
  public:
    CUserSegm(CField<4> _userID=0, CField<3> _age=0, CField<1> _gender=0, CField<7> _loc=0, CField<3> _devT=0)
      : userID(_userID)
      , age(_age)
      , gender(_gender)
      , location(_loc)
      , devType(_devT)
    { }
    void setUserID(CField<4> _userID) { userID = _userID; }
    void setUserAge(CField<3> _age) { age = _age; }
    void setUserGender(CField<1> _gender) { gender = _gender; }
    void setUserLocation(CField<7> _loc) { location = _loc; }
    void setDeviceType(CField<3>_devT) { devType =_devT; }
    CField<4> getUserID( ) const { return userID; }
    CField<3> getUserAge( ) const { return age; }
    CField<1> getUserGender( ) const { return gender; }
    CField<7> getUserLocation( ) const { return location; }
    CField<3> getDeviceType( ) const { return devType; }
    unsigned long serialize(bool in, unsigned long stream[], unsigned long_loc)
    {
      _loc = userID.serialize(in, stream, _loc);
      _loc = age.serialize(in, stream, _loc);
      _loc = gender.serialize(in, stream, _loc);
      _loc = location.serialize(in, stream, _loc);
      _loc = devType.serialize(in, stream, _loc);
      return_loc;
    }
  private:
    CField<4> userID: // User ID: 16 lehetoseg: 4 bit
    CField<3> age;  // Age (10 éves intervallumokban 0-10, 10-20, ...): 8 lehetoseg: 3 bit
    CField<1> gender; // Gender: 2 lehetoseg: 1 bit
    CField<7> location; // Location: 128 lehetoseg: 7 bit
    CField<3> devType; // Device type: 8 lehetoseg: 3 bit
  };
  //---------------------------------------
  class CMiscSegm
  {
  public:
    CMiscSegm(CField<8>_diffLevel=0, CField<10>_optData=0)
      : diffLevel(_diffLevel)
      , optionalData(_optData)
    { }
    void setDifficultyLevel(CField<8>_diffLevel) { diffLevel =_diffLevel; }
    void setOptionalData(CField<10>_optData) { optionalData =_optData; }
    CField<8> getDifficultyLevel( ) const { return diffLevel; }
    CField<10> getOptionalData( ) const { return optionalData; }
    unsigned long serialize(bool in, unsigned long stream[], unsigned long_loc)
    {
      _loc = diffLevel.serialize(in, stream,_loc);
      _loc = optionalData.serialize(in, stream,_loc);
      return_loc;
    }
  private:
    CField<8> diffLevel; // Difficulty level the user reached to be rewarded: 256 lehetoseg: 8 bit
    CField<10> optionalData; // Application specific optionally used data: 1024 lehetoseg: 10 bit
  };
protected:
  static void data2segm(const CData& data, CPromoSegm& ps, CApplSegm& as, CUserSegm& us, CMiscSegm& ms, CField<21>&
crc);
  static void segm2data(  CData& data, CPromoSegm& ps, CApplSegm& as, CUserSegm& us, CMiscSegm& ms, CField<21>&
crc);
  static bool data2code(const CData& data, CCode& code);
  static bool code2data(CData& data, const CCode& code);
public:
//------------------------------------------------------------------------------
  static void test( );
  static void encryptData(CCode& code, CPromoSegm& ps, CApplSegm& as, CUserSegm& us, CMiscSegm& ms);
  static bool decryptData(const CCode& code, CpromoSegm& ps, CApplSegm& as, CUserSegm& us, CMiscSegm& ms);
};
#endif // !defined(AFX_PROMOCODEGEN_H_C713E7BC_8909_4EC1_80C0_074516619968_INCLUDED_)
// PromoCodeGen.cpp: implementation of the CPromoCodeGen class.
//
//////////////////////////////////////////////////////////////////////
#include “stdafx.h”
#include “PromoCodeGen.h”
#ifdef_DEBUG
#undef THIS_FILE
static char THIS_FILE[]=_FILE_;
#define new DEBUG_NEW
#endif
// Divider must occupy 21 bits
static const unsigned long s_Divider = 0x001AF5C6;
static const unsigned long s_Remainder = 0x000D4F71;
//////////////////////////////////////////////////////////////////////
// class CData
//////////////////////////////////////////////////////////////////////
CData::CData( )
  :str(0)
{
  memset(data, 0, sizeof(data));
}
CData::CData(const CData& o)
  :str(0)
{
    memcpy(data, o.data, sizeof(data));
}
CData::˜CData( )
{
  delete [ ] str;
}
const CData& CData::operator= (const CData& o)
{
  if( this != &o )
  {
    memcpy(data, o.data, sizeof(data));
    delete [ str;
    str = 0;
  }
  return *this;
}
bool CData::operator== (const CData& o) const
{
  return (memcmp(data, o.data, sizeof(data)) == 0);
}
const char* CData::toString( ) const
{
  if( !str )
  {
    long len = sizeof(data) * 2 + sizeof(data)/sizeof(data[0]) + 1;
    str = new char [len];
  }
  str[0] = 0;
  for(long i = 3; i >= 0; −−i )
  {
    sprintf(str + strien(str), “%.8lx.”, data[i]);
  }
  str[strlen(str)−1] = 0;
  return str;
}
void CData::reset( )
{
  for( long i = 0; i < 4; ++i )
    data[i] = 0;
}
bool CData::isNull( ) const
{
  for( long i = 0; i < 4; ++i )
    if( data[i] > 0 )
      return false;
  return true;
}
unsigned long CData::divide(unsigned long div)
{
  unsigned long rem = 0;
  unsigned long s_div = ULONG_MAX / div;
  unsigned long s_rem = ULONG_MAX % div;
    if( s_rem == div−1
  {
    s_div += 1;
    s_rem = 0;
  }
  else
    s_rem += 1;
  for(long i = DATA_LENGTH−1; i >= 0; −−i )
  {
    unsigned long dv1 = (rem * s_rem) / div;
    unsigned long rm1 = (rem * s_rem) % div;
    unsigned long dv2 = data[i] / div;
    unsigned long rm2 = data[i] % div;
    data[i] = s_div * rem + dv1 + dv2;
    rem = rm1 + rm2;
    if( rem >= div )
    {
      data[i] += 1;
      rem %= div;
    }
  }
  return rem;
}
void CData::mul32x32(unsigned long m1, unsigned long m2, unsigned long& rsLo, unsigned long& rsHi)
{
#if defined(_DEBUG) && !defined(UNDER_CE)
  ULONGLONG rs = UInt32x32To64(m1, m2); // Warning: not suppported under CE !!!
  unsigned long_rsLo = (unsigned long)(rs);
  unsigned long_rsHi = (unsigned long)(rs >> 32);
#endif
  // UInt32x32To64 replaced with an own algorithm
  {
    unsigned long m1lo = LOWORD(m1);
    unsigned long m1hi = HIWORD(m1);
    unsigned long m2lo = LOWORD(m2);
    unsigned long m2hi = HIWORD(m2);
    // ...
    rsHi = m1hi * m2hi;
    rsLo = m1lo * m2lo;
    // ...
    unsigned long rs1 = m1lo * m2hi;
    unsigned long rs2 = m2lo * m1hi;
    if( ULONG_MAX − rs1 < rs2 )
    {
      rs1 = rs2 − (ULONG_MAX − rs1 + 1);
      rs2 = 0x00010000 + (rs1 >> 16);
      rs1 = (rs1 << 16);
    }
    else
    {
      rs1 += rs2;
      rs2 = (rs1 >> 16);
      rs1 = (rs1 << 16);
    }
    // ...
    if( ULONG_MAX − rsLo < rs1 )
    {
      rsHi += 1;
      rsLo = rs1 − (ULONG_MAX − rsLo + 1);
    }
    else
      rsLo += rs1;
    rsHi += rs2;
  }
#if defined(_DEBUG) && !defined(UNDER_CE)
  if( (rsLo != _rsLo) ∥ (rsHi != _rsHi) )
  {
    ::MessageBox(NULL, “mul32x32 failed!”, “Errors”, MB_OK|MB_ICONEXCLAMATION);
  }
#endif
}
void CData::multiply(unsigned long mul)
{
  unsigned long rem = 0;
  for(long i = 0; i < DATA_LENGTH; ++i )
  {
    unsigned long rsLo, rsHi;
    mul32x32(data[i], mul, rsLo, rsHi);
    if( ULONG_MAX − rsLo < rem )
    {
      rsHi += 1;
      rsLo = rem − (ULONG_MAX − rsLo + 1);
    }
    else
      rsLo += rem;
    rem = rsHi;
    data[i] = rsLo;
  }
}
void CData::add(unsigned long add)
{
  unsigned long rem = add;
  for(long i = 0; i < DATA_LENGTH; ++i )
  {
    if( ULONG_MAX − data[i] >= rem )
    {
      data[i] += rem;
      break;
    }
    else
    {
      data[i] = rem − (ULONG_MAX − data[i] + 1);
      rem = 1;
    }
  }
}
/////////////////////////////////////////////////////////////////////
// class CCode::CIterator
/////////////////////////////////////////////////////////////////////
CCode::CIterator::CIterator(const CCode& ccode)
  : codeObj(ccode)
{
  reset( );
}
void CCode::CIterator::reset( )
{
  ndx = 0;
}
bool CCode::CIterator::hasNext( )
{
  const char* code = codeObj.toString( );
  const long clen = strlen(code);
    while( ndx < clen )
  {
    if( *(code + ndx) == codeObj.getSeparator( ) )
      ++ndx;
    else
      return true;
  }
  return false;
}
char* CCode::CIterator::getNext( )
{
  const char* code = codeObj.toString( );
  return (char*)(code + ndx++);
}
/////////////////////////////////////////////////////////////////////
// class CCode::CRevIterator
//////////////////////////////////////////////////////////////////////
CCode::CRevIterator::CRevIterator(const CCode& ccode)
  : codeObj(ccode)
{
  reset( );
}
void CCode::CRevIterator::reset( )
{
  const char* code = codeObj.toString( );
ndx = strlen(code) − 1;
}
bool CCode::CRevIterator::hasPrev( )
{
  const char* code = codeObj.toString( );
    while( ndx >= 0 )
  {
    if( *(code + ndx) == codeObj.getSeparator( ) )
      --ndx;
    else
      return true;
  }
  return false;
}
char* CCode::CRevIterator::getPrev( )
{
  const char* code = codeObj.toString( );
  return (char*)(code + ndx--);
}
/////////////////////////////////////////////////////////////////////
// class CCode
/////////////////////////////////////////////////////////////////////
CCode::CCode(char separator, long sepAfterEvery, const char* codestr)
  : sepChr(separator)
{
  nSep = (CODE_LENGTH−1) / sepAfterEvery;
  seps = new long [nSep];
  code = new char [CODE_LENGTH + nSep + 1];
    memset(code, ‘0’ CODE_LENGTH + nSep);
  code[CODE_LENGTH + nSep] = 0;
  for( long i = 0; i < nSep; ++ i )
  {
    if( i = = 0 )
      seps[i] = sepAfterEvery;
    else
      seps[i] = seps[i − 1] + sepAfterEvery + 1;
    code[ seps[i] ] = sepChr;
  }
  long  n = 0;
  const char* p = codestr;
  CIterator it(*this);
  while( p && *p && it.hasNext( ) )
  {
    if( ((*p>=‘0’) && (*p<=‘9’)) ∥
        ((*p>=‘A’) && (*p<=‘Z’)) ∥
        ((*p>=‘a’) && (*p<=‘z’)) )
    {
      *(it.getNext( )) = toupper(*p);
    }
    ++p;
  }
}
CCode::CCode(char separator, long* sepPositions, long sepPosCount, const char* codestr)
  : sepChr(separator)
{
  nSep = sepPosCount;
  seps = new long [nSep];
  code = new char [CODE_LENGTH + nSep + 1];
    memset(code, ‘0’ CODE_LENGTH + nSep);
  code[CODE_LENGTH + nSep] = 0;
  for( long i = 0; i < nSep; ++ i )
  {
    seps[i] = sepPositions[i];
    code[ seps[i] ] = sepChr;
  }
  long  n = 0;
  const char* p = codestr;
  CIterator it(*this);
  while( p && *p && it.hasNext( ) )
  {
    if( ((*p>=‘0’) && (*p<=‘9’)) ∥
        ((*p>=‘A’) && (*p<=‘Z’)) ∥
        ((*p>=‘a’) && (*p<=‘z’)) )
    {
      *(it.getNext( )) = toupper(*p);
    }
    ++p;
  }
}
CCode::CCode(const CCode& o)
{
  nSep = o.nSep;
  seps = new long [nSep];
  for( long i = 0; i < nSep; ++i )
    seps[i] = o.seps[i];
  code = new char [CODE_LENGTH + nSep + 1];
  strcpy(code, o.code);
}
CCode::˜CCode( )
{
  delete [ ] code;
  delete [ ] seps;
}
const CCode& CCode::operator= (const CCode& o)
{
  if( this != &o )
  {
    nSep = o.nSep;
    delete [] seps;
    seps = new long [nSep];
    for( long i = 0; i < nSep; ++i )
      seps[i] = o.seps[i];
    delete [ ] code;
    code = new char [CODE_LENGTH + nSep + 1];
    strcpy(code, o.code);
  }
  return *this:
}
bool CCode::operator== (const CCode& o) const
{
  return (strcmp(code, o.code) == 0);
}
void CCode::reset( )
{
  memset(code, ‘0’, CODE_LENGTH + nSep);
  code[CODE_LENGTH + nSep] = 0;
  for( long i = 0; i < nSep; ++ i )
  {
    code[ seps[i] ] = sepChr;
  }
}
/////////////////////////////////////////////////////////////////////
// class CPromoCodeGen
/////////////////////////////////////////////////////////////////////
//---------------------------------------------------------------------------------------
void CPromoCodeGen::test( )
{
}
//---------------------------------------------------------------------------------------
void CPromoCodeGen::encryptData(CCode& code, CPromoSegm& ps, CApplSegm& as, CUserSegm& us, CMiscSegm& ms)
{
  CField<21> crc;
  CData  data, data2;
  segm2data(data2, ps, as, us, ms, crc);
  crc.field = (s_Remainder + s_Divider − data2.divide(s_Divider)) % s_Divider;
  segm2data(data, ps, as, us, ms, crc);
  data2code(data, code);
}
bool CPromoCodeGen::decryptData(const CCode& code, CPromoSegm& ps, CApplSegm& as, CUserSegm& us, CMiscSegm&
ms)
{
  CField<21> calculatedCRC;
  CField<21> readedCRC;
  CData  data, data2;
  if( !code2data(data, code) )
    return false;
  data2segm(data, ps, as, us, ms, readedCRC);
  segm2data(data2, ps, as, us, ms, calculatedCRC); // data2 = data without CRC
  calculatedCRC.field = (s_Remainder + s_Divider − data2.divide(s_Divider)) % s_Divider;
  if( readedCRC == calculatedCRC )
    return true;
  else
    return false;
}
//-----------------------------------------------------------------------------
void CPromoCodeGen::data2segm(const CData& data, CPromoSegm& ps, CApplSegm& as, CUserSegm& us, CMiscSegm& ms,
CField<21>& crc)
{
  unsigned long _loc = 0;
  // todo: break CRC in several segments
  _loc = ps.serialize(true, data.getData( ), _loc);
  _loc = as.serialize(true, data.getData( ), _loc);
  _loc = us.serialize(true, data.getData( ), _loc);
  _loc = ms.serialize(true, data.getData( ), _loc);
  crc.serialize(true, data.getData( ), _loc);
}
void CPromoCodeGen::segm2data(CData& data, CPromoSegm& ps, CApplSegm& as, CUserSegm& us, CMiscSegm& ms,
CField<21>& crc)
{
  unsigned long _loc = 0;
  // todo: break CRC in several segments
  _loc = ps.serialize(false, data.getData( ), _loc);
  _loc = as.serialize(false, data.getData( ), _loc);
  _loc = us.serialize(false, data.getData( ), _loc);
  _loc = ms.serialize(false, data.getData( ), _loc);
    crc.serialize(false, data.getData( ), _loc);
}
//-----------------------------------------------------------------------------
bool CPromoCodeGen::data2code(const CData& data, CCode& code)
{
  CPromoSegm ps(27, 888);
  code.reset( );
  CData  dt = data;
  CCode::CRevIterator rit(code);
  while( !dt.isNull( ) && rit.hasPrev( ) )
  {
    unsigned long rm = dt.divide(36);
    char*  pChr = rit.getPrev( );
    if( rm < 10 )
      *pChr = ‘0’ + (char)rm;
    else
      *pChr = ‘A’ + (char)(rm − 10);
  }
  return true;
}
bool CPromoCodeGen::code2data(CData& data, const CCode& code)
{
  unsigned long  dgt;
  CCode::CIterator it(code);
  data.reset( );
  while( it.hasNext( ) )
  {
    char* pChr = it.getNext( );
    if( (*pChr > ‘0’) && (*pChr <= ‘9’) )
      dgt = (unsigned long)(*pChr − ‘0’);
    else
    if( (*pChr >= ‘A’) && (*pChr <= ‘Z’) )
      dgt = 10 + (unsigned long)(*pChr − ‘A’);
    else
      return false;
    data.multiply(36);
    data.add(dgt);
  }
  return true;
}
```

1. A system for distribution and management of electronic vouchers (coupons) comprising:
(a) a Carrier Application constituted by a software program operable by a user on a computing device;
(b) a Promotion Code Generator embedded in said Carrier Application configured to generate a unique promotion code when a user operates the Carrier Application in a predetermined manner; and
(c) an Award Service Website accessible on the Internet which is configured to maintain an award account for a user and to receive a submission of a promotion code generated by the Promotion Code Generator in a Carrier Application for validation and crediting to the user's award account as a validated promotion award corresponding to the promotion code submitted, whereupon the user can transfer, exchange, and/or redeem the validated promotion award.

2. A system according to claim 1, wherein the computing device is a mobile device from the group consisting of: laptops; PDAs; PDA-phones; and digital phones.

3. A system according to claim 1, wherein the Carrier Application comprises a set of questions or tasks in an educational or fun game program to be performed by the user, and the user is awarded a promotion code upon achieving a specified level of play, result, or score.

4. A system according to claim 3, wherein the promotion code is generated from one or more parameters of the group consisting of: game name or ID; game copy number; user ID; user age; user location; device type; promotion type; promotion ID; award won; date; time; promotion code index number; and user score.

5. A system according to claim 1, further comprising a Promotion Partners Website accessible by a promotion partner on the Internet which is configured to maintain a promotion account for a promotion partner desiring to initiate an electronic voucher promotion, and to enable the promotion partner to specify parameters for the generation of promotion codes representing respective promotion awards from a selected Carrier Application to be distributed to users in the promotion; and
wherein the promotion codes submitted to the Award Service Website to be validated are sent to the Promotion Partners Website to be checked against the parameters specified for the promotion, and validated promotion award codes are returned to the Award Service Website if the promotion codes fall within the parameters specified for the promotion.

6. A system for distribution and management of electronic vouchers (coupons) comprises:
(a) a Promotion Partners Website accessible by a promotion partner on the Internet which is configured to maintain a promotion account for a promotion partner to initiate an electronic voucher promotion, and to enable the promotion partner to specify parameters for the generation of promotion codes representing respective promotion awards from a selected Carrier Application to be distributed to users in the promotion;
(b) a Carrier Application constituted by a software program operable by a user on a computing device having embedded therein a Promotion Code Generator configured to generate an electronic voucher represented by a promotion code when the user operates the Carrier Application in a predetermined manner;
(c) means for configuring a Carrier Application selected by a promotion partner on the Promotion Partners Website so that its Promotion Code Generator is loaded with the capability to generate selected promotion codes when a user operates the Carrier Application in the predetermined manner; and
(d) means for distributing copies of the Carrier Application to be operated on computing devices of users participating in the promotion so as to generate promotion codes from their operation of the Carrier Application in the predetermined manner; and
(e) means for allowing users to submit promotion codes generated by the distributed copies of the Carrier Application for validation of promotion awards to the users and for tracking the status of the promotion awards through the participating partner's promotion account.

7. A system according to claim 6, wherein the Promotion Partners Website is configured to enable a participating partner to initiate a promotion by selecting a Carrier Application and a total number or denominated value of promotion awards to be awarded through the Carrier Application.

8. A system according to claim 7, wherein with each promotion initiated, a Promotion Bank is established in the partner's account to monitor the status of promotion awards validated and/or redeemed in that promotion.

9. A system according to claim 8, wherein the status of the specified promotion awards in the Promotion Bank is initially “free”, but is changed to “validated” with each promotion code that is submitted and validated.

10. A system according to claim 6, wherein the Carrier Application loaded for generating promotion codes is transmitted to the one or more distribution websites to be used for downloading copies of the Carrier Application to users.

11. A system according to claim 6, wherein copies of the Carrier Application are distributed to users offline through physical distribution channels such as in stores, promotion packs, publication inserts, etc.

12. A system according to claim 6, further comprising an Award Service Website accessible by users on the Internet which is configured to maintain an award account for a user and to receive a submission of a promotion code generated by the Promotion Code Generator to be validated and credited to the user's award account as a validated promotion award corresponding to the promotion code submitted, whereupon the user can transfer, exchange, and/or redeem the validated promotion award with other users or with a participating partner, or with a participating redemption center or website.

13. A system according to claim 12, wherein the promotion codes submitted to the Award Service Website are sent to the Promotion Partners Website to be checked against the parameters specified for the promotion, and validated promotion award codes are returned to the Award Service Website if the promotion codes fall within the parameters specified for the promotion.

14. A system according to claim 8, wherein the number of promotion codes and/or number of copies of the Carrier Application distributed is unlimited, while the number of promotion codes that may be validated as promotion awards is limited by the total number or denominated value of promotion awards specified in the Promotion Bank.

15. A system according to claim 14, wherein when a user redeems a promotion award, the status of the promotion award in the Promotion Bank is changed back to “free”, so that the promotion award maintained by the Promotion Bank may be used for validating a next submitted promotion code, whereby promotion awards can be repetitively and regeneratively issued and circulated through the Promotion Bank.

16. A system according to claim 8, wherein the number of promotion codes and number of copies of the Carrier Application distributed is limited by the total number or denominated value of promotion awards specified for the Promotion Bank, and each copy of the Carrier Application can generate only a limited number of promotion codes that it is loaded with, and promotion codes submitted to the Promotion Bank are validated up to the allowed number or denominated value.

17. A system according to claim 8, wherein the number of promotion codes and/or number of copies of the Carrier Application distributed is unlimited, and the promotion codes are validated for award points which can be accumulated in the user's award account for redemption of a promotion award from the Promotion Bank, so that an unlimited numbers of award points may be repetitively and regeneratively issued to users, subject to the availability of promotion awards maintained in the Promotion Bank.

18. A method for distribution of electronic vouchers (coupons) from a software carrier application operable on a computing device comprising:
(a) installing a Carrier Application on a user's computing device;
(b) providing a Promotion Code Generator embedded in said Carrier Application which is configured to generate a promotion code when a user operates the Carrier Application in a predetermined manner; and
(c) awarding an electronic voucher to the user in the form of a unique promotion code generated by the Promotion Code Generator when the user operates the Carrier Application in the predetermined manner, displaying the promotion code and any associated promotion information to the user on a display interface for the computing device, and storing the generated promotion code in memory on the computing device for later retrieval for validation, exchange and/or redemption.

19. A method for distribution of electronic vouchers according to claim 18, wherein promotion codes are repetitively generated whenever the user operates the Carrier Application in the predetermined manner until one or more events of the following group occur: (i) an expiration date for the generation of promotion codes is reached; (ii) an allowed number of promotion codes to be generated is reached and no more codes are to be generated; and (iii) no more promotion awards can be validated for the promotion codes.

20. A method for distribution of electronic vouchers according to claim 18, wherein the Carrier Application is a downloadable game software, and the user's computing device is a mobile computing device such as a laptop, PDA, PDA-phone, or digital phone.
